(19) United States
(12) Patent Application Publication
(10) Pub. No.: US 2004/0153330 A1
(43) Pub. Date: Aug. 5, 2004

(54) System and method for evaluating future collateral risk quality of real estate

(75) Inventors: Norman Miller, Cincinnati, OH (US); Greg Hansen, San Diego, CA (US); Mark Sennott, Sherborn, MA (US); Mike Sklarz, Honolulu, HI (US)

Correspondence Address: BANNER & WITCOFF, 1001 G STREET N W, SUITE 1100, WASHINGTON, DC, 20001, US

(73) Assignee: Fidelity National Financial, Inc., Irvine, CA

(21) Appl. No.: 10/358,280

(22) Filed: Feb. 5, 2003

(51) Int. Cl. G06F 17/60

(52) U.S. Cl. 705/1; 705/36

(57) ABSTRACT

An apparatus and method is provided for evaluating default and foreclosure loss risk, both at time zero and for several years into the future, associated with a piece of real property on the basis of factors such as statistical home price trend information for a metropolitan statistical area (MSA) in which the real property is located and loan terms. An automated valuation estimate for the property is obtained and compared to the purchase price. A loan-to-value ratio is determined based on automated valuation estimate. A future home price is predicted based on statistical data obtained for a metropolitan statistical area (MSA) in which the real property is located. Based on the future home price and the LTV ratio, a probability that the real property will have negative equity is determined, and a risk score is generated based on the probability. Other features include generating base scores for each of a plurality of future years and obtaining a weighted average of the base scores; adjusting the risk score based on liquidity of real property values for the MSA in which the real property is located; adjusting the risk score based on reliability of data for the real property; adjusting the risk score based on price volatility for the MSA in which the real property is located; and using unemployment data in the MSA for which the real property is located in calculating the risk score.

### FIELD OF THE INVENTION

The invention relates generally to computer-implemented systems and methods for evaluating the risk quality of real estate. More specifically, the invention provides a computer-implemented process for assessing certain risks associated with a particular piece of real estate based on various factors.

### BACKGROUND OF THE INVENTION

In recent years, lenders have relied on various “scoring” tools to evaluate the creditworthiness of applicants. One well-known scoring system, known as the Fair Isaac Credit Organization score (FICO), rates the creditworthiness of potential borrowers based on various factors such as repayment history, and assigns a score that can then be used by mortgage lenders to make lending decisions. Such scoring systems allow lending decisions to be made quickly.

The mortgage industry also relies on property value determinations, frequently involving a human appraiser, in order to determine how much money to lend for a particular piece of property. In recent years, various types of automated valuation models (AVMs) have been developed in an attempt to automate the process of property value estimation. Such models are not always accurate, since there are many factors that go into making a property value determination, some of which can vary more frequently than others. Moreover, such models are highly dependent on the accuracy of data provided and what trends or other predictors are factored into the analysis.

Conventional AVM models may not account for economic conditions in the area in which the property is located, and may not reliably predict future home prices in the area in which the property is located. For example, a number of economic conditions such as household incomes, interest rates, and unemployment rates in a metropolitan statistical area (MSA) may impact future home prices, yet those conditions may not be exploited to determine future valuation risk associated with a particular piece of property in the MSA. Given that the local economy impacts home prices, such deficiencies can lead to errors and uncertainty in future years. Moreover, the valuation may not take into account the availability of data for the particular property.

What is needed is a way of overcoming the above and other limitations of evaluating real estate, such as residential properties, for purposes such as risk determination, and for predicting collateral risk quality with accuracy.

### SUMMARY OF THE INVENTION

The invention provides a computer-implemented system and method for evaluating certain risks associated with a piece of real estate. The invention takes into account economic conditions for the metropolitan area in which the property is located, allowing forward-looking projections to be incorporated into a score that can be quickly and easily used to assist in determining the risk associated with the property. Much like a credit score, the present invention contemplates generating a score associated with a piece of property. The score can be generated instantaneously based on electronically available information and databases.

In various embodiments, a computer-implemented method evaluates current and projected future economic conditions in the area in which the subject property is located, as well as current value risk (based on historical and recent volatility of prices in the vicinity of the property), the future value risk (probability of negative equity in the future) and liquidity and relative price. These factors, in combination with input data such as a purchase price and loan-to-value ratio, are used to generate a score that is useful for evaluating the risk quality of the property. A high score would indicate that the property is a good risk, whereas a low score would indicate a poor risk for collateral valuation purposes.

In certain embodiments, each of a plurality of factors is weighted to generate a final score. In some embodiments, the score can take into account the creditworthiness of the property owner or buyer. Other embodiments and variations will become apparent through the following detailed description, the figures, and the appended claims.

### BRIEF DESCRIPTION OF THE DRAWINGS

FIG. 1 is a flow chart showing process steps for evaluating collateral quality and generating a score based on various factors according to the invention.

FIG. 2 is a flow chart showing details of step 104 of FIG. 1 according to one embodiment of the invention.

FIG. 3 shows a computer system employing various principles of the invention.

FIG. 4 shows one possible mapping between probability of negative equity and base risk scores.

### DETAILED DESCRIPTION OF THE INVENTION

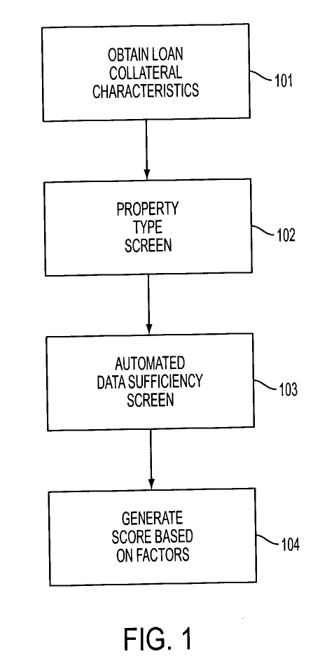

FIG. 1 shows process steps for evaluating collateral quality and generating a risk score based on various factors according to one variation of the invention. The process will be described generally, followed by a more detailed description of exemplary embodiments. The steps shown in FIG. 1 and the other figures can be carried out on a general-purpose computer programmed with appropriate software, such as a spreadsheet or high-level computer language.

First, in step 101, loan collateral characteristics are collected for a loan that is to be secured for the property. Such characteristics may include, but are not limited to, the type of loan; the type of property and its address; the purchase price; the loan amount and terms; and the loan-to-value ratio at origination.

In step 102, a property type screening test is performed. In certain embodiments, only residential property (e.g., single-family home, condominium, or planned unit developments) is scored, and other types of property (e.g., mobile homes, agricultural properties, and commercial properties) are not scored. Therefore, in those variations of the invention in which only residential properties are to be scored, non-qualifying properties are excluded from the evaluation process.

In step 103, an automated data sufficiency screening test is performed. If insufficient data is available for a particular property (e.g., no economic data is available for the MSA in which the property is located and no prices for other homes in the vicinity are available), the evaluation process may be terminated for the property. (This step is optional) There are several alternative sources of data that may be used for the data sufficiency test, including assessment data from county recorder offices; multiple listing service data; and self-reported data in stored archive files, such as appraisal and home transaction records captured and archived by a title company, mortgage lender, or other entity involved in lending or purchasing.

There may be situations where insufficient data makes any sort of valuation process statistically unreasonable. This may result from a lack of automated public records or from ultra thin markets with little sales activity. For example, if there are no comparable properties in a multiple listing service (MLS) within a certain distance (e.g., a half-mile) of the subject property, it could be disqualified from automatic scoring. As another example, if there is no current assessment data available from the county for the subject property, it may be disqualified from automatic scoring. As yet another example, a “thin” market may exist where fewer than a threshold number of comparable sales within a prior time period for a given MSA or sub-MSA region. Nevertheless, the inventive principles are not limited to any particular sufficiency level of data.

Finally, in step 104, the property is evaluated according to various factors as set forth in more detail below. In the preferred embodiment, a score is generated corresponding to the risk quality of the property based on the factors. The following example illustrates one possible assignment of scores for input data items, where higher scores indicate lower collateral risk.

NO SCORE (0): Occurs when the property does not meet the property type screening test (single family, condo or PUD) or the property does not have any immediately retrievable data available.

LOW SCORE (0-500): Occurs when the property type meets the screening test and the evaluation process suggests that the risk of negative equity (explained in further detail below) is fairly high. This score will typically occur in less than 10% of all scored cases.

MODERATE SCORE (500-700): Occurs when the property type meets the property screening test and the data is sufficient to predict accurately the probability of negative equity and the risk is typical that negative equity may occur.

HIGH SCORE (700-900): Occurs when the property type meets the screening test and there is sufficient data to determine probability of negative equity and that risk is very low.

VERY HIGH SCORE (900-1000): Occurs when the property type meets the screen test; there is sufficient data to determine probability of negative equity and that risk is very low; and the property exhibits highly marketable and liquid attributes.

Other assignments of scores or similar indicators can of course be used to indicate the quality or risk associated with a piece of property.

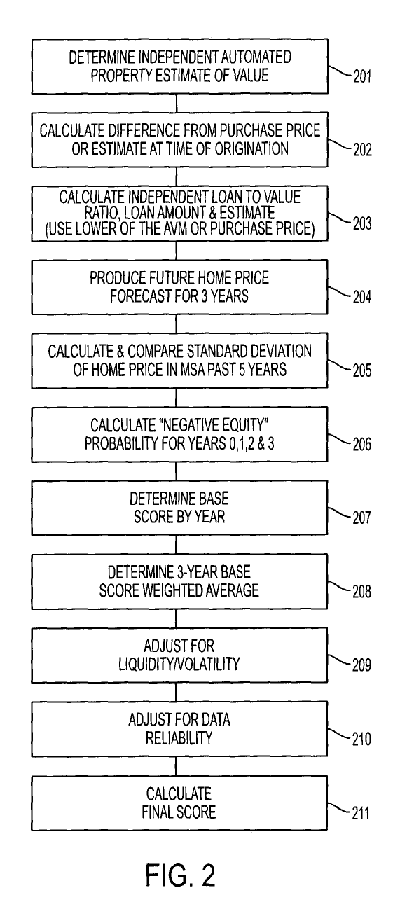

FIG. 2 provides a more detailed explanation of one embodiment of step 104. Beginning in step 201, an independent automated property value estimate is obtained for the property. This may be obtained using any of various automated property valuation models, such as Freddie Mac's Home Value Explorer™; the CASA™ model from Case Schiller Weiss; a system such as that shown in WIPO publication number WO 02/19216 (“Value Your Home”); or others. In step 202, the difference between the purchase price (or price estimate) at the time of origination and the AVM-derived value is calculated. This provides information that the purchase price is above or below the AVM value. The lower of these values is used below as an estimate of true value. In step 203, an independent loan-to-value (LTV) ratio is calculated based on the loan amount and estimated value. In one embodiment, the lower of the AVM-derived value or the purchase price is used to derive the LTV ratio.

Alternatively, the lender or other user of the process may input an LTV directly. (The LTV ratio can be used to calculate the amount of money borrowed; e.g., for a $100,000 house and an LTV of 80%, the amount of the mortgage would be $80,000. Calculation of LTV is an optional step and need not be performed in every case).

In step 204, the future home price is forecast for a future time period (e.g., the next 3 years beyond the current year). Several forecast models can be used depending on the area of the country and depth of data. These models are generally at the MSA (metropolitan statistical area) level or within smaller geographically defined submarkets (e.g., zip codes, census tracts, census blocks and combinations thereof). The determining factors in the selection of the model used are (1) the availability of data, and (2) the accuracy and statistical fit based on prior testing. In one variation, MSA-level forecasts can always be run. If there are many submarkets within an MSA (e.g., Orange County, California), separate models can also be created by city, zip code, or Census Block Group level based upon the historical relationship with these and the MSA level model.

There are many ways of defining a submarket, which reflects an attempt to select properties that are similar enough to the subject property to be potential substitutes. Factors such as price range, size, age, political boundaries like a city or state line, physical obstacles like lakes or mountains or highways can all be used to determine an area of similar properties. Defining a submarket can be done by using block groups and adding more blocks as long as the adjacent blocks are within a fairly similar band of key parameters, such as price range, size, and age of the home. Another simple way to define a market is to rely on zip codes to define submarket boundaries. In one embodiment, submarkets across the country are defined on the basis of price ranges and geographic addresses. Appraisers refer to submarkets as “neighborhoods;” a similar concept is contemplated in accordance with the invention but with more generality.

According to one variation of the invention, the process involves repeatedly running models that include fundamental indications of the interaction of demand and supply such as employment and household income trends as well as auto regressive terms that capture serial correlation in the price trends and cycles. One generalized model comprises a multiple regression equation where housing prices, HP, in time t are a function of an “intrinsic value”, based on AP, the affordable price defined below, and fundamental economic variables, FE, as well as technical factors like prior house prices. β's represent regression coefficients. FE is based on changes in employment, or local gross area product, or unemployment rates, or similar economic data that influences longer term housing demand. The notation t−n indicates that various leads are used within the model from t to n years prior to the current year. Prices are all in nominal terms.

HPₜ=β₁(AP)ₜ+β₂(FE)ₜ+β₃(HP)ₜ₋ₙ+ε

Here AP is calculated as follows: HHMIₘₛₐ/M/AMC_{i,n}/LTV where HHMI is the local MSA median household income. M is the inverse of the allowable portion of household income that Freddie Mac uses for prime mortgage loan purchase, that is if 25% is allowed then M=4.0, AMC is the annualized mortgage constant equal to the monthly mortgage constant times 12 for the current mortgage interest rate, i, and term, n which effectively results in the present value of the payment stream or the supportable value of a mortgage using the local median income available for the debt service. LTV is the loan to value ratio. The standard deviation of the forecast is based on the prior standard deviation calculated from historical data for the same market area as from which the forecast of future prices is derived. The future prices are standardized into a percentage change in value expected each period and this percentage change in value is applied to the subject property under analysis.

In some variations of the invention, FE can represent a single parameter, such as an employment rate in the MSA or submarket; in others, FE can represent several variables all run independently, so that the FE represents a term that could be multiple variables, each with its own regression coefficient β. There are of course many different ways of running regression models with different parameters to predict future housing prices in a particular MSA or submarket. In the equation, ε represents an error term that is not explained by any variables. In one embodiment, an average error is equal to the average absolute deviation from the HP actual number.

In step 205, the standard deviation of the home price in the Metropolitan Statistical Area (MSA) in which the property is located is calculated and compared to the standard deviation of the local submarket. The larger standard deviation may be used in the calculations below. In one embodiment, at least one submarket is used, although it may be a crude submarket such as a zip code. The local submarket is based on a geographical information system that selects properties as close to the subject property under analysis as possible. Greater distance from the subject is essential until there is a significant sample and all properties should be within the same submarket as defined by a similar price range, size, and age. Comparable property is selected as close to the subject property as possible. If there are many recent sales within a few blocks then this may provide a sufficient statistical sample to run the valuation model. If there are only a few sales within a few blocks of the subject property then comparable property should be sought that is further away measured by either feet, miles, or drive time in minutes or by block adjacency to the block in which the subject property is situated. The goal is to select properties based on minimizing the distance as described herein and maximizing sample size simultaneously. These two parameters can be traded off in an optimizing framework that seeks sufficiency in both of the parameters with enough data and as close proximity to the subject as possible. The greater standard deviation for the MSA or the submarket can be used for estimating the probability of negative equity as described below.

In step 206, a “negative equity” probability is calculated for years 0, 1, 2, and 3. “Negative equity” is the situation that occurs when a property's value is less than a principal balance owed on the mortgage loan, and most frequently occurs in markets with declining prices. Negative equity can also occur in other situations, such as when the LTV is 95% but a faulty appraisal provides an inflated valuation for the property. Negative equity is assessed based on a probability factor. The probability function in one embodiment provides a predictive indicator and is based on a cumulative density function as follows: P(NE) at t=P(E<0)=cndf{(log(V)−log(M))/Square Root of Var of V}

where P(NE)=probability of NE, Negative Equity, at time t

E=equity in the home

V=value estimate (AVM value for year 0 and price forecast for future years). In one variation, the value estimate for year zero can be determined as follows. One or more independent AVM models are run to determine value estimates for the property. Then similar properties in the MSA or submarket in which the property is located are also identified, and a regression model is run using the AVM models for actual sales prices of the similar properties. The regression coefficients are then used to weight the AVM models for the subject property, such that a weighted average of the AVM value estimates is obtained, where the more “accurate” AVM models for the subject property are given more weight. Other approaches can of course be used.

In one variation, the price forecast for future years can be obtained using a price forecast model such as a multiple regression model of the type described above that takes into account local economic factors such as employment rates.

M=mortgage value based on the balance at time t

The square root of the variance of V is based on the home value estimate for the submarket or metropolitan market variance, whichever is larger.

The cndf cumulative normal density function is the proportion of a normal distribution that falls into the negative equity range.

The procedure is repeated for each future year. For each future year, the principal balance on the loan is calculated and the new home price is determined. These two factors are used to provide a single point estimate of the equity in the property for each future year. The standard deviation expected for the forecasts is used and the measure of negative equity probability is determined for each future year. As the loan is paid down, the probability of negative equity typically decreases unless the future home prices are expected to decline, in which case equity will be shrinking.

In step 207, a base score is determined by year (0, 1, 2, and 3) for the property. The base score is a distribution that is a function of the probability of negative equity and corresponding risk of default. In one variation, the average base score is set to approximate the average home loan and the chances of default, about 5%. In one embodiment, the average score of about 620 will correspond to the average risk of default for a typical mortgage with typical loan to value parameters in a typical market within the United States. These parameters may change over time with the market, but in 2002 the typical loan to value ratio would be just slightly above 80%.

For example, the score can be set so as to become increasingly difficult at a non-linear rate such that only very low risk loans can achieve the highest score. Some 30% to 40% of all loans may end up in the very low risk category based on lower loan to value ratios and or more certainty with respect to the home value estimate. At the low end, scores under 500 indicate a much higher risk of default. The vast majority of properties will see a range of scores run from 300 to 900. In every year the exact same procedure is used except that the value estimate is based upon an updated price, adjusted for the general market trends and the loan balance will decline with mortgage principal repayments. Thus, the terms of the loan are explicitly considered in the mortgage balance calculation equal to the present value of the remaining payments over the remaining term discounted at the contract of interest on the mortgage.

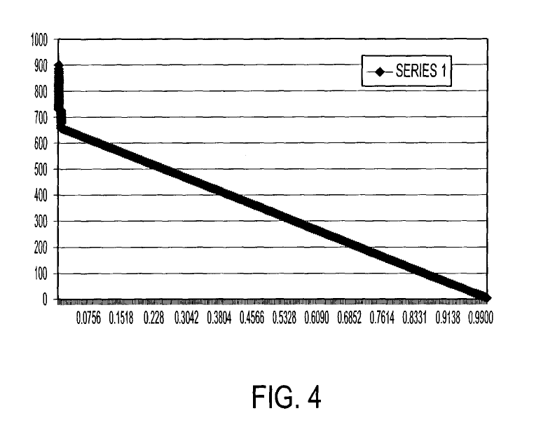

FIG. 4 shows one possible mapping of probability values to base scores according to one variation of the invention. The vertical axis in FIG. 4 represents the base scores corresponding to negative equity probability values along the horizontal axis. As can be seen in FIG. 4, there is a sharp drop-off followed by a decline in score values corresponding to negative equity probabilities. (FIG. 4 is plotted on a log scale, which makes exponentials appear to be linear). In this exemplary embodiment, the graph is comprised of three segments: a first segment stretching from score 900 to a score of about 651; a second segment stretching from a score of about 651 to a score of about 500; and a third segment stretching from a score of about 500 to a score of zero. (In another variation, a cut-off score of 300 can be established, such that no score below that level is assigned). In this exemplary embodiment, scores in the first two segments follow a geometrically declining rate, where the rate of decline in the first segment is higher than the rate of decline in the second segment. The rate of decline in the third segment follows essentially a linear decline.

Examples of 10 data points (probabilities and corresponding scores) from the first segment are reproduced below:

| | |
|---|---|
| 0 | 900 |
| 0.0001 | 884 |
| 0.0002 | 870 |
| 0.0003 | 856 |
| 0.0004 | 843 |
| 0.0005 | 832 |
| 0.0006 | 821 |
| 0.0007 | 810 |
| 0.0008 | 801 |
| 0.0009 | 792 |
| 0.001 | 783 |

Examples of 10 data points (probabilities and corresponding scores) from the second segment are reproduced below:

| | |
|---|---|
| 0.0176 | 651 |
| 0.0177 | 650 |
| 0.0178 | 650 |
| 0.0179 | 650 |
| 0.018 | 650 |
| 0.0181 | 650 |
| 0.0182 | 650 |
| 0.0183 | 650 |
| 0.0184 | 650 |
| 0.0185 | 650 |

Examples of 10 data points (probabilities and corresponding scores) from the third segment are reproduced below:

| | |
|---|---|
| 0.2365 | 500 |
| 0.2366 | 500 |
| 0.2367 | 500 |
| 0.2368 | 500 |
| 0.2369 | 500 |
| 0.237 | 500 |
| 0.2371 | 500 |
| 0.2372 | 500 |
| 0.2373 | 500 |
| 0.2374 | 500 |

In step 208, a weighted average of the multi-year base scores is determined. In one embodiment, for example, the current (zero) year score can be multiplied by 0.4; the first year score can be multiplied by 0.3; the second year score can be multiplied by 0.2; and the third year score can be multiplied by 0.1. The multiplied values are added to arrive at a weighted average, where the current year's score carries the most weight. Other schemes for assigning weights can be used.

In step 209, an adjustment is generated to account for relative pricing and liquidity/volatility. The relative pricing score is simply an index that adds or subtracts as much as 50 points from the base score. In this score, properties are rated based on how they fit into the price range distribution; that is, if a property is priced so as to be in the top tier or very bottom tier of the local submarket, the property is deemed less liquid. In one embodiment, sales prices in the submarket are stratified into 10 deciles from lowest to highest. If the subject property has an estimated value that falls within the top or bottom decile, 50 points are subtracted from the base score. If the subject property has an estimate value that falls within the middle two deciles, 50 points are added to the base score. Values falling within the other deciles are adjusted using smaller adjustments.

In the second liquidity score, time on the market can be considered as an additional parameter. Time on the market is compared from the local submarket to the regional and national average time on the market for a similar time of year. Properties in a submarket with lower than average time to sale are considered more liquid. Consequently, 50 points can be added if the property is in a submarket having a low average time on the market (e.g., 1 to 24 days), whereas a fewer number of points can be added if the average is higher. If the property is in a submarket having a high average time on the market (e.g., 51 days or more), points can be subtracted from the base score.

Finally, the typicality of the property can be considered as another liquidity measure. Property that is typical receives no plus or minus scores. Property that is unusually unique (a typical) will receive a lower or negative score. Each property has so many square feet, so many bedrooms, baths, is of a certain age, and so forth. Each of these parameters will also have a mean and standard deviation for the local submarket. When a given subject property under analysis does not fit close to the normal part of the distribution for one or more of these parameters then the property is unique. This can be quanitified as well as relative pricing by comparing the subject property to the tier within which it resides. If it resides in an outside tier, such as the top ten percent, then it will get a lower score. The scores are scaled so that one can score up to a plus or minus 50 for relative pricing and also for liquidity based on uniqueness.

These two parameters (relative pricing, and liquidity as measured by time on the market and/or typicality) are used to generate a total of up to 100 additional points (50 for relative pricing and 50 for liquidity) or as much as 100 points subtracted. A property may receive +50 for pricing but −50 for a low time on the market or typicality score and so it could end up at zero, or any combination from −100 to +100. Together these scores are stratified into a normal distribution with points assigned from −100 for less liquid and poorly positioned in terms of pricing to +100 for highly normal, well positioned in terms of price and very liquid.

In step 210, an adjustment can be made for data reliability. The above model requires a great deal of data. When data is not available from any reliable source, such as public records, data vendors, proprietary survey data, then the automated model cannot be applied and a manual process may be required. The absence of any reliable data may indicate that the market is rather thin in activity. In one embodiment, if insufficient data is available (e.g., only one sale within one mile of the subject property within the past 3 years), a minimum value (e.g., 300) is assigned as the score.

In step 211, a final score is calculated. In one variation, this is generated as the sum of the base score; the relative liquidity score; and the relative pricing in the market. If the sum is greater than 1000 (highest permitted), then 1000 is substituted as the score.

In another embodiment of the invention, the final score is weighted according to a creditworthiness score of the loan applicant, such as a FICO score. Low FICO scores are generally associated with a high rate of default, while high FICO scores are generally associated with a lower rate of default. Consequently, the final score can be weighted according to the corresponding FICO or similar creditworthiness score of the purchaser of the property. In this embodiment, a low FICO score will be given more weight than the risk score generated by the inventive method, and a high FICO score will be given less weight than the risk score generated by the inventive method. One possible weighting scheme is shown below:

FICO under 500: final score=0.7×FICO+0.3×SCORE

FICO 500-550: final score=0.6×FICO+0.4×SCORE

FICO 550-600: final score=0.5×FICO+0.5×SCORE

FICO 600-650: final score=0.45×FICO+0.55×SCORE

FICO above 650: final score=0.4×FICO+0.6×SCORE

This overall score is a single index that could be used to assign the overall risk of the mortgage considering all major default risks. With the additional consideration of prepayment risks this score could be used to develop a risk profile of every loan or all the loans in a portfolio. A portfolio can be compared to a national benchmark portfolio or tranched into various risk levels for use in the mortgage backed securities market.

The following provides an example of how a risk score can be generated for a property. Suppose that the subject property is located in the hypothetical zip code of 12345 (submarket) in the Washington, D.C. Metropolitan Statistical Area (MSA). Suppose further that the relevant information for this property for this MSA and submarket is as follows:

Current median house price for this MSA: $236,000

Current median house price for submarket 12345 in this MSA: $248,000

Purchase price for subject property: $255,000

Standard deviation of housing prices for all properties in submarket: $15,000. (Two different standard deviations can be determined: one for comparable properties, and one for the submarket as a whole; the larger of the two deviations can be used for the purpose of scoring).

Loan details: 30-yr fixed rate mortgage at 7.0% interest; loan amount $204,000 (20% down or 80% LTV based on purchase price)

Average time on market of houses for this submarket: 30 days

Relative pricing of subject property compared to submarket: 7^{th} decile

Uniqueness of property compared to submarket: typical

Availability of data indicator (yes, data is available)

Affordable price for MSA, LTV, and interest rate (calculated per above): $227,000

Fundamental economic variable FE (based on local employment and/or other factors)

Prior median house prices for the submarket (from database)

Calculation of the score would proceed as follows. First, an AVM estimate of the current property value is obtained, using a commercially available AVM product. Suppose that the AVM estimate shows the property value to be $230,000. (One or more AVM models can be run and corresponding estimates weighted according to projected accuracy based on a regression model, as discussed above). Second, the AVM estimate is compared to the purchase price, and the lower of the two values ($230,000) is determined. Third, the LTV ratio is calculated using the lower of the two values, resulting in an LTV of 89%. (Note that the LTV ratio based on the AVM value is higher than the LTV based on the actual purchase price. Also note that calculation of LTV is optional.) Fourth, a price estimate is obtained for the subject property for the next 3 years using a price forecast model, such as a multiple regression model based on factors such as those identified above (affordable price AP at time t, fundamental economic variable(s) FE at time t, and historical housing price HP at time t−n). Suppose that this price prediction shows, based on local economic conditions in the MSA and submarket, that the subject property will have a future value in years 1, 2, and 3 of $230,000, $240,000, and $250,000 respectively.

Fifth, the probability of negative equity is determined for each year (0, 1, 2, and 3) as a function of V (the value estimate for each year), M (the mortgage balance at time t), and the square root of the variance of V for the submarket. (Future variances can be estimated based on the current variance and projected forward). The value for the current year (0) can be determined based on the AVM price, whereas the value for the future years (1 through 3) can be determined using a price forecasting model such as the multiple regression model as discussed above.

Sixth, the probability of negative equity is used to calculate a base score for each of the years reflecting a corresponding risk of default. In one embodiment, the probability of negative equity is determined using a relation such as that shown in FIG. 4 and discussed above. As a hypothetical example, suppose that the corresponding base scores for years 0, 1, 2, and 3 are 621, 640, 651, and 655, respectively. In general, as the mortgage balance decreases and expected house price increases, the score for each year will likely be higher.

Seventh, a weighted average of the base scores is determined, for example by applying weights of 0.4, 0.3, 0.2, and 0.1. The weighted average base score would then be 636.

Eighth, the base score of 636 is adjusted to account for the median time on the market for houses in the submarket; relative liquidity; and relative pricing, as follows:

Add 40 points for favorable time on the market value in this submarket.

Add 25 points for typicality (e.g., the property has exactly the median number of bedrooms and bathrooms for the submarket).

Add 25 points for relative pricing (7^{th} decile)

The total of the above adjustments results in a risk score of 720.

Finally, the score can be further adjusted to take into account the creditworthiness of the loan applicant. For example, if the applicant has a FICO score of 530, one possible weighted score taking FICO into account would be:

0.6×530+0.4×720=606.

In accordance with one aspect of the invention, a score can be generated that incorporates both the historical and future forecast of home prices for a given property, as well as the variability of the current value estimate of the property. Conventional mortgage scoring only uses a point estimate of the value of the property, and no forecast of the future direction of the price of the property. Additionally, negative equity can be evaluated on the basis of more than an appraised value. The use of liquidity measures and consideration of relative price and price variation risk can also be taken into account. Forecast values can be used to estimate risk of default or losses from foreclosure.

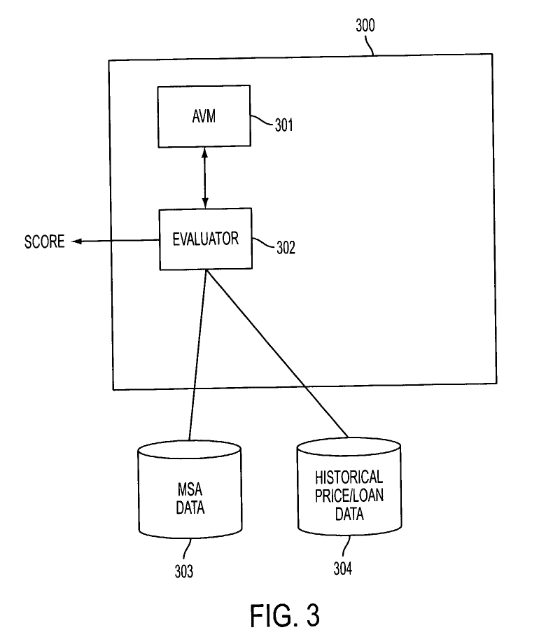

FIG. 3 shows a system according to various principles of the invention. A general-purpose computer 300 includes an evaluator 302 which may, for example, comprise a computer program written in a computer language, or a spreadsheet containing macros for carrying out the inventive principles. A conventional Automated Valuation Model 301 is used in conjunction with evaluator 302 to generate an automated valuation for the subject property.

Database 303 may comprise information pertaining to a plurality of Metropolitan Statistical Areas (MSAs), such as Atlanta, Houston, and Miami. Examples of information maintained for each MSA may include median housing prices; unemployment figures; inflation rates; interest rates; and the like. This information can be used to forecast future housing prices for a property located in each such area using conventional multiple regression techniques.

Database 304 may comprise historical information concerning loans, defaults, prices, and similar data. For example, the risk of default for a given loan shows a general correlation to the LTV ratio. Database 304 may include historical or heuristic data reflecting this correlation. This database may include one or more tables, for example, that map probability of default to LTV ratios. These values can be generated in the aggregate or they can be broken down by MSA for more precise scoring.

A user (not shown) enters input values corresponding to the items in step 101 of FIG. 1 using forms or other input screens. Thereafter, evaluator 302 uses AVM 301 to generate an independent property estimate of value. Evaluator 302 then executes one or more steps as shown in FIG. 2 to generate a score, which is then output to the user or printed on a report. The score is useful to lenders, appraisers, risk managers, underwriters, and other entities that need to assess the risk quality associated with a piece of real estate.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. Any of the method steps described herein can be implemented in computer software and stored on computer-readable medium for execution in a general-purpose or special-purpose computer, and such computer-readable media is included within the scope of the intended invention.

We claim:

1. A computer-assisted process for evaluating risks associated with real property, comprising the steps of, in a general-purpose computer:
(1) determining a probability of negative equity for the real property as a function of a future mortgage value and a future predicted value for the real property;
(2) establishing a base score for the real property for each of a plurality of future years as a function of the probability of negative equity determined in step (1); and
(3) generating a risk score indicative of future risk associated with the real property as a function of the base score established for each of the plurality of future years.

2. The computer-assisted process of claim 1, wherein step (1) comprises the step of determining the probability of negative equity as a function of variability of prices within a statistical grouping of properties.

3. The computer-assisted process of claim 2, wherein step (1) comprises the step of determining the probability of negative equity as a function of the variance of prices within a submarket.

4. The computer-assisted process of claim 1, wherein step (1) comprises the step of generating a cumulative normal density function based on a value estimate for the real property and the future mortgage value.

5. The computer-assisted process of claim 4, further comprising the step of using an automated valuation model (AVM) to generate a value estimate for a current year and using the value estimate for the current year to determine a probability of negative equity for the current year.

6. The computer-assisted process of claim 1, wherein the probability in step (1) is determined according to the following relation:
P(NE) at t=P(E<0)=cndf{(log(V)−log(M))/Square Root of Var of V}
where P=probability of NE, Negative Equity, at time t; V=value estimate; M=mortgage value based on the balance at time t; the square root of the variance of V is based on the larger of the value estimate for the submarket or metropolitan market variance, whichever is larger; and the cndf cumulative normal density function is the proportion of a normal distribution that falls into a negative equity range.

7. The computer-assisted process of claim 1, wherein step (1) comprises the step of determining the probability of negative equity as a function of a future price based on economic variables for a metropolitan statistical area in which the real property is located.

8. The computer-assisted process of claim 7, wherein step (1) comprises the step of determining a future price on the basis of a multiple regression analysis, where prices in time are a function of an affordable price and fundamental economic variables for a statistical area in which the real property is located.

9. The computer-assisted process of claim 8, wherein step (1) comprises the step of determining the future price on the basis of local employment statistics.

10. The computer-assisted process of claim 8, wherein step (1) comprises the step of determining the future price on the basis of median household income for a statistical area in which the real property is located.

11. The computer-assisted process of claim 1, wherein step (2) comprises the step of establishing a base score associated with a risk of default.

12. The computer-assisted process of claim 1, wherein step (3) comprises the step of generating the risk score as a weighted average of the base score established for each of the plurality of future years established in step (2) and using the weighted average to produce a score indicative of risks associated with the real property.

13. The computer-assisted process of claim 1, further comprising the step of:
(4) adjusting the risk score on the basis of how a price of the real property fits into a price range distribution for a submarket in which the real property is located.

14. The computer-assisted process of claim 13, wherein step (4) comprises the step of adjusting downwardly the risk score if a price of the real property is in an upper tier of the price range distribution and adjusting upwardly the risk score if the price of the real property is in a lower tier of the price range distribution.

15. The computer-assisted process of claim 1, further comprising the step of:
(4) adjusting the risk score on the basis of how long properties in a statistical market in which the real estate is located have been on the market.

16. The computer-assisted process of claim 1, further comprising the steps of:
(4) adjusting the risk score on the basis of relative pricing in the local market; and
(5) adjusting the risk score on the basis of relative liquidity in the local market.

17. The computer-assisted process of claim 1, further comprising the step of adjusting the risk score on the basis of a creditworthiness score of a loan applicant associated with the real property.

18. The computer-assisted process of claim 1, wherein step (1) comprises the step of determining the probability of negative equity as a function of local market conditions.

19. A computer-assisted process for evaluating real property, comprising the steps of, in a general-purpose computer:
(1) establishing an automated valuation estimate for the real property;
(2) predicting a future price for the real property based on statistical data pertinent to an area in which the real property is located;
(3) determining, based on steps (1) and (2), a probability that the real property will have a negative equity in a future time period; and
(4) generating a risk score for the real property using the probability determined in step (3).

20. The computer-assisted process of claim 19,
wherein step (3) comprises the step of determining a standard deviation of property prices for a metropolitan statistical area (MSA) in which the real property is located.

21. The computer-assisted process of claim 19,
wherein step (2) comprises the step of predicting the future price over a plurality of future years; and
wherein step (3) comprises the step of determining a probability for each of the plurality of future years and using each said probability to generate the risk score.

22. The computer-assisted process of claim 19, wherein step (4) comprises the step of generating a base score for each of the plurality of future years and weighting each base score to generate the risk score.

23. The computer-assisted process of claim 19, further comprising the step of adjusting the risk score based on liquidity of real estate values for a submarket in which the real property is located.

24. The computer-assisted process of claim 19, further comprising the step of adjusting the risk score based on a median time on the market for properties located in a submarket in which the real property is located.

25. The computer-assisted process of claim 19, further comprising the step of adjusting the risk score based on availability of data for the real property.

26. The computer-assisted process of claim 19, wherein step (2) comprises the step of using unemployment data for the MSA in which the real property is located.

27. The computer-assisted process of claim 19, wherein step (2) comprises the step of using household incomes for the MSA in which the real property is located.

28. The computer-assisted process of claim 19, wherein step (1) comprises the step of obtaining a plurality of automated valuation model (AVM) value estimates for the real property and weighting each of the plurality of AVM value estimates in accordance with regression coefficients based on actual data obtained for a submarket in which the real property is located.

29. The computer-assisted process of claim 19, further comprising the step of weighting the risk score according to a creditworthiness score of a mortgage applicant associated with the real property.

30. The computer-assisted process of claim 19, wherein step (2) comprises the step of predicting a future home price on the basis of the following multiple regression relation:
HPₜ=β₁(AP)ₜ+β₂(FE)ₜ+β₃(HP)ₜ₋ₙ+ε
Where AP=HHMIₘₛₐ/M/AMC_{i,n}/LTV where HHMI is the local MSA median household income; M is the inverse of an allowable portion of household income for mortgage loan purchases; AMC is an annualized mortgage constant equal to the monthly mortgage constant times 12 for the current mortgage interest rate, i, and term, n; and LTV is the loan to value ratio;
Where FE represents local economic conditions;
Where HP represents historical house price data;
Where β₁,β₂,β₃ represent regression coefficients; and
Where ε is an error parameter.

31. A computer programmed to carry out the process of claim 19.

32. A computer-implemented process for evaluating risks associated with real property, comprising the steps of, in a general-purpose computer:
(1) generating a plurality of automated valuation estimates for the real property;
(2) weighting each of the plurality of automated valuation (AVM) price estimates according to regression coefficients reflecting data for a submarket in which the real property is located, and generating a weighted AVM price estimate for a current year;
(3) generating a predicted future price for each of a plurality of future years for the real property using a regression model that takes into account local economic conditions in a submarket in which the real property is located;
(4) determining for each of the plurality of future years a probability that the real property will have a negative equity on the basis of the predicted future price; a mortgage balance for each future year; and a variance of prices for the submarket in which the real property is located;
(5) generating a risk score for the real property using the probability determined in step (4); and
(6) adjusting the risk score to account for liquidity in the submarket.
